(19) United States
(12) Patent Application Publication
(10) Pub. No.: US 2026/0368632 A1
(43) Pub. Date: Nov. 19, 2026

(54) TRAINING DATA SELECTION APPARATUS, TRAINING DATA SELECTION METHOD, AND STORAGE MEDIUM

(71) Applicant: KABUSHIKI KAISHA TOSHIBA, Kawasaki-shi Kanagawa (JP)

(72) Inventors: Yanni REN, Tokyo (JP); Tenta SASAYA, Urayasu Chiba (JP); Takahiro TAKIMOTO, Yokohama Kanagawa (JP)

(73) Assignee: KABUSHIKI KAISHA TOSHIBA, Kawasaki-shi Kanagawa (JP)

(21) Appl. No.: 19/447,433

(22) Filed: Jan. 13, 2026

(30) Foreign Application Priority Data
Jan. 15, 2025 (JP) 2025-005228

(51) Int. Cl. G06N 20/00

(52) U.S. Cl. CPC G06N 20/00

(57) ABSTRACT

According to one embodiment, a training data selection apparatus includes a processing circuit. The processing circuit is configured to predict, based on unlabeled data, class information related to a prediction class to which the unlabeled data is predicted to belong; compute, from labeled data belonging to each class, a maximum additional training data count of each of the classes; compute training data order of each of the classes from the maximum additional training data count of each of the classes; and select additional labeled data, based on the class information, the maximum additional training data count and the training data order of each of the classes, and a planned training data count.

### CROSS-REFERENCE TO RELATED APPLICATION

This application is based upon and claims the benefit of priority from Japanese Patent Application No. 2025-005228, filed Jan. 15, 2025, the entire contents of which are incorporated herein by reference.

### FIELD

Embodiments described herein relate generally to a training data selection apparatus, a training data selection method, and a storage medium.

### BACKGROUND

Classification tasks using AI (neural networks) are widely known and utilized in various fields. To increase the accuracy of classification, training data used for training is essential, and in particular, labeled data is important. Since in fields such as medical and manufacturing industries, specialized knowledge is required, there is a problem that data labeling work is expensive and time consuming. As one of approaches to solve this problem, there is a method in which data to be used for training is selected among unlabeled data planned to be labeled using trained AI and the selected data is labeled. However, this method leads to deterioration of classification performance in the case of class imbalance data in which a count of data for each class is biased.

To address this, a technique for coping with class imbalance has been proposed. In the technique, all classes are roughly divided into a minority class and a majority class, and data belonging to the minority class is labeled.

However, in the technique, all the data belonging to the minority class cannot be labeled within a limited planned training data count, and training processing cannot be completed. Therefore, in the technique, class imbalance cannot be reduced within the limited planned training data count.

### BRIEF DESCRIPTION OF DRAWINGS

FIG. 1 is a block diagram illustrating a configuration of a training data selection apparatus according to a first embodiment.

FIG. 2 is a flowchart for describing operation in the first embodiment.

FIG. 3 is a graph for describing the operation in the first embodiment.

FIG. 4 is a graph for describing comparative examples with respect to the first embodiment.

FIG. 5 is a block diagram illustrating a configuration of a training data selection apparatus according to a second embodiment.

FIG. 6 is a flowchart for describing operation in

FIG. 7 is a block diagram illustrating a hardware configuration of the training data selection apparatus according to a third embodiment.

### DETAILED DESCRIPTION

In general, according to one embodiment, a training data selection apparatus includes a processing circuit. The processing circuit is configured to predict, based on unlabeled data, class information related to a prediction class to which the unlabeled data is predicted to belong. The processing circuit is configured to compute, from labeled data belonging to each class, a maximum additional training data count of each of the classes. The processing circuit is configured to compute training data order of each of the classes from the maximum additional training data count of each of the classes. The processing circuit is configured to select additional labeled data, based on the class information, the maximum additional training data count and the training data order of each of the classes, and a planned training data count.

Hereinafter, each embodiment will be described with reference to the drawings. In the following description, a medical image in a medical field will be used as an illustrative example for unlabeled data, but the unlabeled data is not limited to the example. For example, as for the unlabeled data, any data that can be used for a classification task using AI, such as sensor data to be subjected to character recognition, image recognition, prediction, and the like, can be used as appropriate in any field such as the manufacturing industry or the service industry.

### First Embodiment

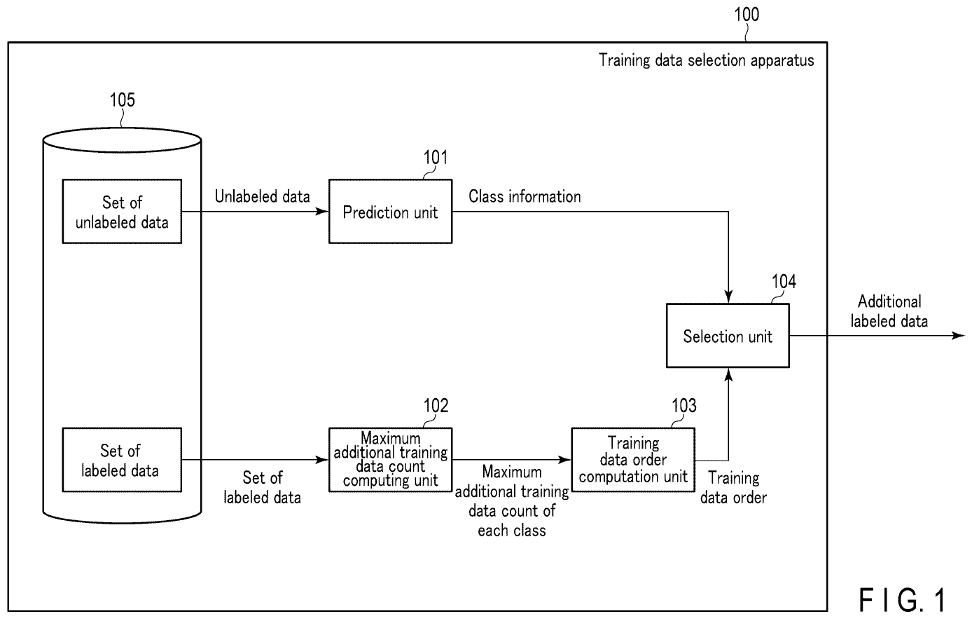

FIG. 1 is a block diagram illustrating a configuration of a training data selection apparatus 100 according to a first embodiment. The training data selection apparatus 100 includes a prediction unit 101, a maximum additional training data count computing unit 102, a training data order computation unit 103, a selection unit 104, and a storage unit 105. Note that the storage unit 105 is a memory that can be read/written from each unit such as the prediction unit 101, the maximum additional training data count computing unit 102, the training data order computation unit 103, and the selection unit 104. The storage unit 105 stores, for example, a set of unlabeled data and a set of labeled data. In addition, the set of unlabeled data may be, for example, a set of unlabeled medical images that are disease images to which labels each indicating a class for identifying a disease name are not yet assigned. Similarly, the set of labeled data may be a set of labeled medical images that are disease images to which the labels are assigned.

Here, the prediction unit 101 predicts, based on unlabeled data acquired from the storage unit 105, class information related to a prediction class to which the unlabeled data is predicted to belong. Specifically, for example, the prediction unit 101 may compute the class information of the unlabeled data, based on the unlabeled data and one or more parameters defining a machine learning model such as a neural network. As the one or more parameters, for example, a weight and a bias can be used as appropriate. The class information includes, for example, a prediction class to which the unlabeled data belongs and a certainty factor indicating a probability of belonging to the prediction class. However, the class information does not necessarily include the certainty factor. In addition, the prediction unit 101 may be an information processing apparatus separate from the training data selection apparatus 100 from the viewpoint of load distribution to the neural network. For example, the prediction unit 101 may be an information processing apparatus such as a cloud server that can communicate with the training data selection apparatus 100.

The maximum additional training data count computing unit 102 computes a maximum additional training data count of each class from labeled data belonging to each class. For example, the maximum additional training data count computing unit 102 may compute, based on a count of the labeled data belonging to each class, an average value of the counts of the labeled data of all the classes, and compute the maximum additional training data count of each class from the average value and the count of the labeled data belonging to each class.

The training data order computation unit 103 computes training data order of each class from the maximum additional training data count of each of the classes. For example, the training data order computation unit 103 may compute the training data order in descending order of the maximum additional training data count of each class. In addition, for example, the training data order computation unit 103 may compute the training data order by randomly selecting a class according to a distribution in which the maximum additional training data count of each class is a probability.

The selection unit 104 selects additional labeled data, based on the class information, the maximum additional training data count and the training data order of each class, and a planned training data count. For example, in a case where the class information includes the prediction class and the certainty factor, the selection unit 104 may determine a class planned for training and a planned class training data count, based on the maximum additional training data count and the training data order of each class and the planned training data count, and select, as additional labeled data, unlabeled data within the range of the planned class training data count in descending order of the certainty factor from the unlabeled data having the same prediction class as the class planned for training.

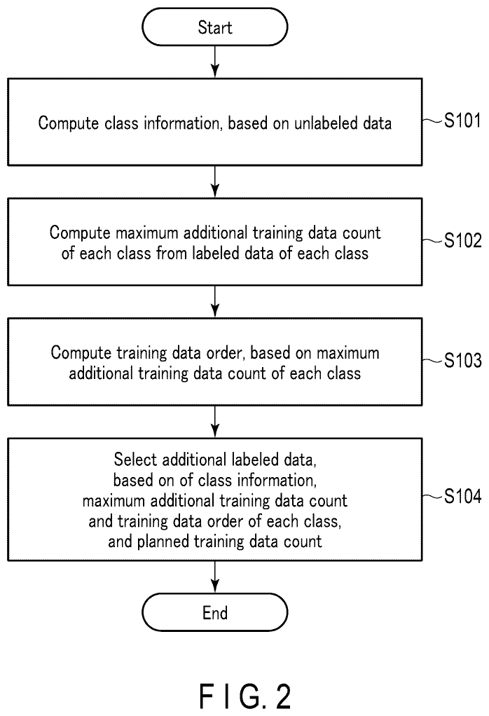

Next, with reference to FIGS. 2 to 4, the operation of the training data selection apparatus 100 configured as described above will be described. In the following description, it is assumed that the storage unit 105 of the training data selection apparatus 100 stores the set of unlabeled data and the set of labeled data in advance. The whole of the two sets is a set of class imbalance data in which a count of data for each class is biased.

First, as illustrated in FIG. 2, the prediction unit 101 acquires the unlabeled data from the storage unit 105 and computes the class information, based on the unlabeled data (Step S101). For example, the prediction unit 101 computes the class information from the unlabeled data, based on one or more parameters. Note that examples of the one or more parameters include a weight and a bias. A set of the one or more parameters defines a machine learning model, for example, a neural network. In other words, the prediction unit 101 inputs the unlabeled data to the neural network defined by the parameters, and the neural network generates the class information to compute the class information.

Specifically, for example, the neural network generates a certainty factor for each prediction class of a disease represented by an unlabeled disease image, based on the unlabeled disease image that is unlabeled data, and outputs class information including the prediction class and the certainty factor.

After Step S101, the maximum additional training data count computing unit 102 acquires the set of labeled data from the storage unit 105, and computes the maximum additional training data count of each class from the labeled data belonging to each class in the set (Step S102). For example, the maximum additional training data count computing unit 102 computes the average value of the counts of the labeled data of all the classes, based on the count of the labeled data belonging to each class. For example, in the case where all the classes are defined as seven classes, each class is identified by Ci (however, i=0, . . . , 6), a count of labeled data belonging to each class Ci is defined as Li, and an average value is defined as μ, the average value μ is expressed as the following formula.

μ=(L0+L1+L2+L3+L4+L5+L6)/7

Thereafter, the maximum additional training data count computing unit 102 computes the maximum additional training data count of each class from the average value μ and the count Li of the labeled data belonging to each class Ci. Here, in the case where μ>Li, a maximum additional training data count Ti of each class Ci is expressed as the following formula.

Ti=μ−Li

Note that in the case of μ<Li, since the class Ci is a majority class, there is no maximum additional training data count.

After Step S102, the training data order computation unit 103 computes the training data order, based on the maximum additional training data count Ti of each class Ci (Step S103). For example, the training data order computation unit 103 defines the training data order of each class in descending order of the maximum additional training data count Ti of each class Ci. In other words, the training data order of the class Ci having the largest maximum additional training data count Ti is placed first, and descending order of the maximum additional training data count Ti is defined as the training data order. The class Ci having the smallest maximum additional training data count Ti comes last in the training data order.

After Step S103, the selection unit 104 selects additional labeled data, based on the class information, the maximum additional training data count Ti and the training data order of each class Ci, and the planned training data count (Step S104), and outputs the additional labeled data. For example, in a case where the class information includes the prediction class and the certainty factor, the selection unit 104 determines a class planned for training and a planned class training data count, based on the maximum additional training data count Ti and the training data order of each class Ci, and the planned training data count.

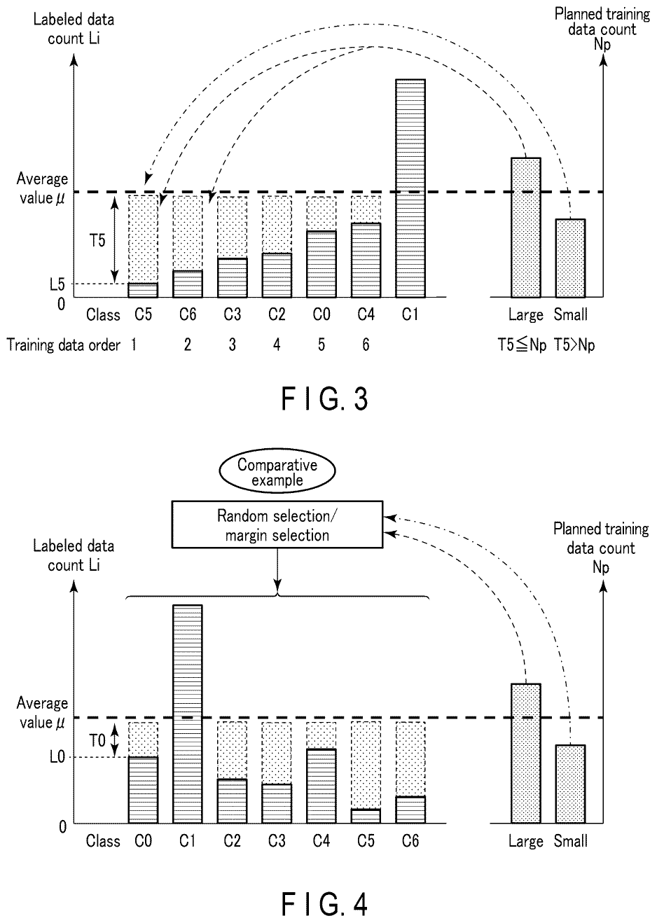

Here, the class planned for training includes the class Ci with the first training data order. A planned class training data count of the class Ci with the first training data order is a maximum additional training data count Ti of the class Ci or a planned training data count Np, whichever is smaller. For example, as illustrated in FIG. 3, it is assumed that there are classes C5, C6, C3, C2, C0, and C4 with the first to sixth training data orders. In this case, the class planned for training includes the class C5 with the first training data order. In the case where T5>Np, a planned class training data count of the class C5 with the first training data order is the same as the planned training data count Np. In addition, for example, in the case where T5≤Np, the class planned for training includes at least the class C6 with the second training data order in addition to the class C5 with the first training data order. In addition, the planned class training data count of the class C5 with the first training data order is a maximum additional training data count T5 of the class C5. A planned class training data count of the class C6 with the second training data order is a maximum additional training data count T6 of the class C6 or the planned training data count Np decreased by subtracting the maximum additional training data count T5 of the class C5 with the first training data order from the planned training data count Np (=Np−T5), whichever is smaller. Similarly, the selection unit 104 determines a class planned for training and a planned class training data count within the range of the decreased planned training data count Np.

After the determination, the selection unit 104 selects unlabeled data within the range of the planned class training data count in descending order of the certainty factor from the unlabeled data having the same prediction class as the class planned for training, and selects the selected unlabeled data as the additional labeled data. For example, the selection unit 104 assigns a label indicating the prediction class of the selected unlabeled data to the selected unlabeled data, thereby selecting the unlabeled data with the label as additional labeled data. Thereafter, the selection unit 104 outputs the additional labeled data.

As illustrated in FIG. 3, the training data selection apparatus 100 as described above computes the training data order with respect to the minority class to which the unlabeled data belongs, and selects the additional labeled data corresponding to the planned training data count according to the training data order. Therefore, class imbalance can be reduced even within the limited planned training data count.

In contrast, as comparative examples, as illustrated in FIG. 4, a case where random selection or margin selection is performed for all classes including the minority class and the majority class will be described. Here, the random selection is a method of randomly selecting each class. The margin selection is a method in which a difference between the prediction probabilities of top two prediction classes with respect to unlabeled data is set as a margin and each class is selected according to ascending order of margins. Note that the ascending order of margins is ascending order of a difference in the prediction probabilities, and means order in which it is difficult to classify into any of the top two prediction classes. In both the random selection and the margin selection, in the comparative examples, additional labeled data corresponding to a planned training data count is selected for all the classes, so that class imbalance cannot be reduced within the limited planned training data count.

Next, a F1 score of training data in the case of using the training data selection apparatus 100 was obtained and compared with the comparative examples. Here, as the training data, an ISIC2018 data set (Task 3: Disease Classification), which is one of the baselines of the classification task of images, was used. ISIC is an abbreviation for international skin imaging collaboration. The F1 score is an evaluation value of the prediction unit 101 that is based on precision and recall of the prediction class, and a higher F1 score is better. As a result of the comparison, a better value of the F1 score in the training data selection apparatus 100 could be obtained compared to values of any of the F1 scores of the random selection and the margin selection as the comparative examples.

As described above, according to the first embodiment, the prediction unit 101 predicts the class information regarding the prediction class to which the unlabeled data is predicted to belong, based on the unlabeled data. The maximum additional training data count computing unit 102 computes the maximum additional training data count Ti of each class Ci from the labeled data belonging to each class Ci. The training data order computation unit 103 computes the training data order of each class Ci from the maximum additional training data count Ti of each class Ci. The selection unit 104 selects additional labeled data, based on the class information, the maximum additional training data count Ti and the training data order of each class Ci, and the planned training data count Np. As described above, with a configuration in which the training data order is computed from the maximum additional training data count of each class, and the labeled data corresponding to the planned training data count is selected according to the training data order, the class imbalance can be reduced even within the limited planned training data count.

In addition, according to the first embodiment, the maximum additional training data count computing unit 102 computes the average value u of the counts Li of the labeled data of all the classes, based on the count Li of the labeled data belonging to each class Ci, and computes the maximum additional training data count Ti of each class Ci from the average value u and the count Li of the labeled data belonging to each class Ci. As described above, with a configuration in which the maximum additional training data count Ti of each class Ci is computed, based on the average value μ of the counts Li of the labeled data of all the classes, it is possible to select additional labeled data for the minority class at or below the average value without excess or deficiency within the planned training data count.

In addition, according to the first embodiment, the training data order computation unit 103 computes the training data order in descending order of the maximum additional training data count Ti of each class Ci. As described above, with a configuration in which the training data order of the smallest minority class having the largest maximum additional training data count Ti is set to the first position, the class imbalance can be reduced intensively with respect to the smallest minority class.

In addition, according to the first embodiment, the training data order computation unit 103 may compute the training data order by randomly selecting a class according to a distribution having the maximum additional training data count Ti of each class Ci as a probability. In this case, with a configuration in which the training data order of the probabilistic minority class can be probabilistically set to the first position according to the maximum additional training data count Ti, the class imbalance can be preferentially reduced with respect to one or more minority classes.

In addition, according to the first embodiment, the class information includes the prediction class to which the unlabeled data belongs and the certainty factor indicating the probability of belonging to the prediction class. The selection unit 104 determines the class planned for training and the planned class training data count, based on the maximum additional training data count Ti of each class Ci, the training data order, and the planned training data count. In addition, the selection unit 104 selects, as additional labeled data, unlabeled data within the range of the planned class training data count in descending order of the certainty factor from the unlabeled data having the same prediction class as the class planned for training. As a result, the unlabeled data of the prediction class can be selected as the additional labeled data in probabilistically accurate order.

### Second Embodiment

A second embodiment is a modification of the first embodiment, and is a mode in which each unit illustrated in FIG. 1 repeats processing until a planned training data count is reached.

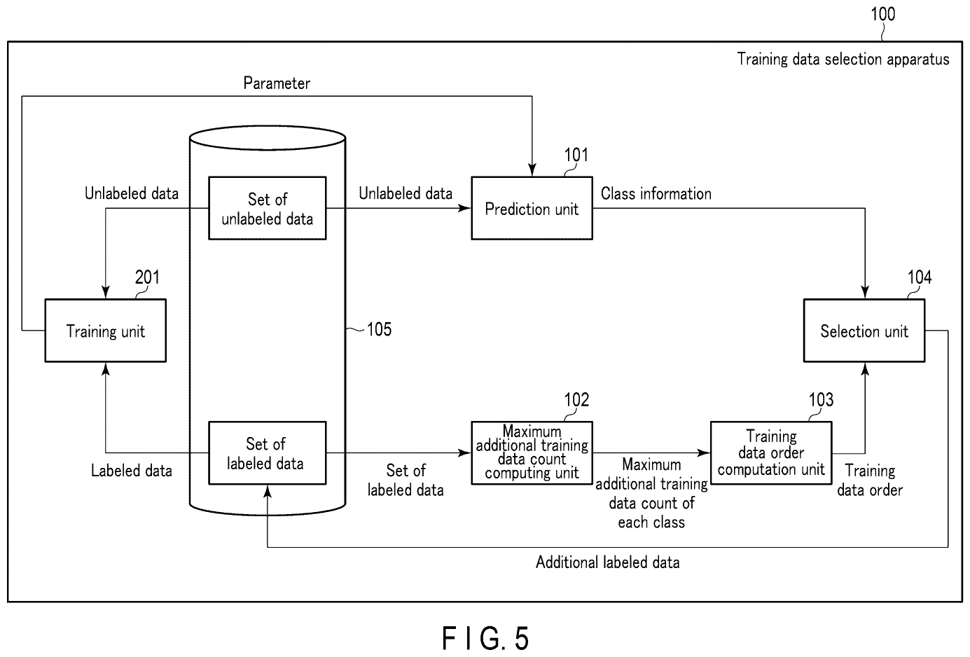

FIG. 5 is a block diagram illustrating a configuration of a training data selection apparatus 100 according to the second embodiment, in which substantially the same parts as those in FIG. 1 are denoted by the same reference signs and detailed description thereof will be omitted, and here, different parts will be mainly described.

The training data selection apparatus 100 further includes a training unit 201 as compared with the configuration illustrated in FIG. 1.

The training unit 201 computes one or more parameters defining a neural network from unlabeled data and labeled data acquired from a storage unit 105, and sends the parameters to a prediction unit 101.

Accordingly, the prediction unit 101 computes class information of the unlabeled data acquired from the storage unit 105 in the same manner as described above, based on the parameters received from the training unit 201.

In addition to the functions described above, a maximum additional training data count computing unit 102 computes the maximum additional training data count of each class, based on the labeled data and additional labeled data.

In addition to the functions described above, the selection unit 104 adds the selected additional labeled data to a set of labeled data in the storage unit 105.

Other configurations are the same as those of the first embodiment.

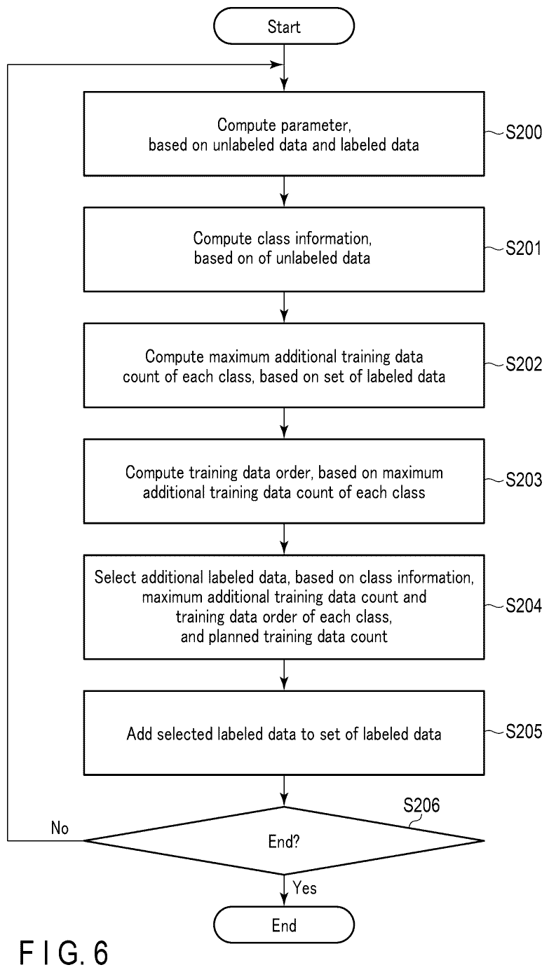

Next, using the flowchart in FIG. 6, the operation of the training data selection apparatus 100 configured as described above will be described.

First, the training unit 201 acquires the unlabeled data and the labeled data from the storage unit 105, computes a parameter, based on the unlabeled data and the labeled data (Step S200), and sends the parameter to the prediction unit 101.

After Step S200, based on the unlabeled data acquired from the storage unit 105 and the transmitted parameter, the prediction unit 101 computes the class information from the unlabeled data (Step S201).

After Step S201, as in Step S102 described above, the maximum additional training data count computing unit 102 acquires the set of labeled data from the storage unit 105, and computes the maximum additional training data count of each class from labeled data belonging to each class in the set (Step S202).

After step S202, as in Step S103 described above, the training data order computation unit 103 computes training data order, based on the maximum additional training data count of each class (Step S203).

After step S203, as in step S104 described above, the selection unit 104 selects additional labeled data, based on the class information, the maximum additional training data count and the training data order of each class, and the planned training data count (Step S204). However, unlike the above, the selection unit 104 does not output the additional labeled data.

After Step S204, the selection unit 104 adds the additional labeled data to the set of labeled data in the storage unit 105 (Step S205). Note that as a result, the storage unit 105 is updated, and a count of labeled data to be used in subsequent repetitive processing becomes a value increased by a count of the added labeled data. Therefore, in the second and subsequent Step S202, the maximum additional training data count computing unit 102 computes the maximum additional training data count of each class, based on the labeled data and the additional labeled data (included in the set of labeled data).

After Step S205, the selection unit 104 determines whether the selection of data has been completed, based on the planned training data count (Step S206). For example, the selection unit 104 records the count of the labeled data added in Step S205, and determines whether the selection of data has been completed according to whether a recorded value of the count of the added labeled data has reached the planned training data count. In a case where the result of the determination in Step S206 is no, the processing proceeds to Step S200, and the processing in Steps S200 to S206 is repeatedly executed on the updated storage unit 105.

On the other hand, in a case where the selection of data has been completed as a result of the determination in Step S206, the processing ends.

As described above, according to the second embodiment, the training unit 201, the prediction unit 101, the maximum additional training data count computing unit 102, the training data order computation unit 103, and the selection unit 104 repeatedly execute the processing until the planned training data count is reached. Note that during the repeated execution of the processing, the maximum additional training data count computing unit 102 computes the maximum additional training data count of each class, based on the labeled data and the additional labeled data. In addition, a count of labeled data belonging to the smallest minority class increases during the repeated execution of the processing, so that training data order of the smallest minority class and the second smallest minority class may be reversed. Therefore, it is possible to reduce class imbalance on average for a plurality of minority classes with relatively high training data order within a limited planned training data count.

### Third Embodiment

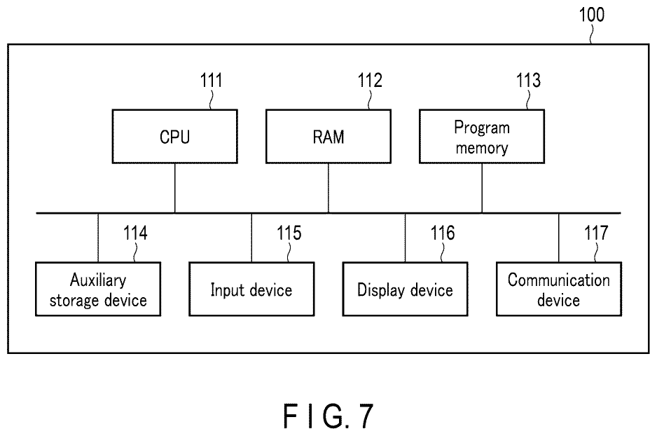

FIG. 7 is a block diagram illustrating an example of a hardware configuration of a training data selection apparatus 100 according to a third embodiment. The third embodiment is a specific example of the first and second embodiments, and is a mode in which the training data Selection apparatus 100 is achieved by a computer.

The training data selection apparatus 100 includes, as hardware, a central processing unit (CPU) 111, a random access memory (RAM) 112, a program memory 113, an auxiliary storage device 114, an input device 115, a display device 116, and a communication device 117. The CPU 111 communicates with the RAM 112, the program memory 113, the auxiliary storage device 114, the input device 115, the display device 116, and the communication device 117 via a bus. In other words, the training data selection apparatus 100 according to the present embodiment is achieved by the computer having such a hardware configuration.

The CPU 111 is an example of a general-purpose processor. The RAM 112 is used as a working memory for the CPU 111. The RAM 112 includes a volatile memory such as a synchronous dynamic random access memory (SDRAM). The program memory 113 stores a program for achieving each function of each unit according to each embodiment in the computer. In addition, as the program memory 113, for example, a read-only memory (ROM), a part of the auxiliary storage device 114, or a combination thereof is used. The auxiliary storage device 114 stores data in a non-transitory manner. The auxiliary storage device 114 includes a nonvolatile memory such as a hard disc drive (HDD) or a solid state drive (SSD).

The input device 115 receives inputs of various operations by a user. As the input device 115, a keyboard, a mouse, various switches, a touch pad, touch panel display, and the like can be used. An electric signal (hereinafter, operation signal) corresponding to the input of the received operation is supplied to the CPU 111.

The display device 116 displays various data under the control of the CPU 111. As the display device 116, a cathode-ray tube (CRT) display, a liquid crystal display, an organic electro luminescence (EL) display, a light-emitting diode (LED) display, a plasma display, or any other display can be appropriately used.

The communication device 117 includes a communication interface such as a network interface card (NIC) for performing data communication with various devices connected to the training data selection apparatus 100 via a network. Note that an operation signal may be supplied to the training data selection apparatus 100 from a computer connected via the communication device 117 or an input device included in the computer, or various data transmitted from the training data selection apparatus 100 may be displayed on a display device or the like included in the computer connected via the communication device 117. Note that in a case where the training data selection apparatus 100 is one apparatus including a personal computer or the like, the supply source of an operation signal is the input device 115, and the display destination of various data is the display device 116. In addition, in a case where the training data selection apparatus 100 is a server apparatus capable of communicating with a client apparatus, the input device 115 can be replaced with a client apparatus connected via the communication device 117 or an input device included in the client apparatus, and the display device 116 can be replaced with a display device or the like included in the client apparatus connected via the communication device 117.

The programs stored in the program memory 113 include computer-executable instructions. If executed by the CPU 111 that is a processing circuit, the program (computer-executable instruction) causes the CPU 111 to execute predetermined processing. For example, if executed by the CPU 111, the program causes the CPU 111 to execute a series of processing described with respect to each unit of FIGS. 1 and 5. For example, the computer-executable instruction included in the program, if executed by the CPU 111, causes the CPU 111 to execute a method that includes at least a portion of the operations described above. The method may include steps corresponding to the functions of the units described above. A part of the program may include a step of executing a trained model stored in the program memory 113.

The trained model may be, for example, a model that is machine-learned using teaching data in which input data that is unlabeled data and output data that is class information of the unlabeled data are associated with each other, and the model may be for causing a computer to execute processing of generating class information, based on the input data.

The program or the trained model may be provided to the training data selection apparatus 100, which is a computer, in a state of being stored in a computer-readable storage medium. In this case, for example, the training data selection apparatus 100 further includes a drive (not illustrated) that reads data from the storage medium, and the training data selection apparatus 100 acquires a program from the storage medium. As the storage medium, for example, a magnetic disk, an optical disk (CD-ROM, CD-R, DVD-ROM, DVD-R, and the like), a magneto-optical disk (MO or the like), a semiconductor memory, or the like can be appropriately used. The storage medium may be referred to as a non-transitory computer readable storage medium. In addition, the program or the trained model may be stored in a server on a communication network, and the training data selection apparatus 100 may download the program or the trained model from the server via the communication device 117. In addition, the computer may execute processing of each unit of the training data selection apparatus 100, based on a program stored in a storage medium, and any configuration such as an apparatus including one such as a personal computer or a system in which a plurality of apparatuses is connected to a network may be used. In the latter case, for example, the system may have a configuration in which a client apparatus is connected, via a network, to a server apparatus that executes processing of each unit illustrated in FIG. 1 or FIG. 5.

The processing circuit that executes the program or the trained model is not limited to a general-purpose hardware processor such as the CPU 111, and a special purpose hardware processor such as an application specific integrated circuit (ASIC) may be used. The term processing circuit includes at least one general purpose hardware processor, at least one special purpose hardware processor, or a combination of at least one general purpose hardware processor and at least one special purpose hardware processor. In the example of the present embodiment, the CPU 111, the RAM 112, and the program memory 113 correspond to the processing circuit.

According to at least one embodiment described above, class imbalance can be reduced even within a limited planned training data count.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A training data selection apparatus comprising:
a processing circuit configured to
predict, based on unlabeled data, class information related to a prediction class to which the unlabeled data is predicted to belong;
compute, from labeled data belonging to each class, a maximum additional training data count of each of the classes;
compute training data order of each of the classes from the maximum additional training data count of each of the classes; and
select additional labeled data, based on the class information, the maximum additional training data count and the training data order of each of the classes, and a planned training data count.

2. The training data selection apparatus according to claim 1, wherein the processing circuit is further configured to compute, based on a count of the labeled data belonging to each of the classes, an average value of counts of labeled data of all the classes, and compute the maximum additional training data count of each of the classes from the average value and the count of the labeled data belonging to each of the classes.

3. The training data selection apparatus according to claim 2, wherein the processing circuit is further configured to compute the training data order in descending order of the maximum additional training data count of each of the classes.

4. The training data selection apparatus according to claim 2, wherein the processing circuit is further configured to compute the training data order by randomly selecting a class according to a distribution in which the maximum additional training data count of each of the classes is a probability.

5. The training data selection apparatus
according to claim 3, wherein
the class information includes a prediction class to which the unlabeled data belongs and a certainty factor indicating a probability of belonging to the prediction class, and
the processing circuit is further configured to determine a class planned for training and a planned class training data count, based on the maximum additional training data count and the training data order of each of the classes and the planned training data count, and select, as the additional labeled data, unlabeled data within a range of the planned class training data count in descending order of the certainty factor from unlabeled data having the same prediction class as the class planned for training.

6. The training data selection apparatus according to claim 5, wherein the processing circuit is further configured to compute the maximum additional training data count of each of the classes, based on the labeled data and the additional labeled data.

7. A training data selection method comprising:
predicting, based on unlabeled data, class information relating to a prediction class to which the unlabeled data is predicted to belong;
computing, from labeled data belonging to each class, a maximum additional training data count of each of the classes;
computing training data order of each of the classes from the maximum additional training data count of each of the classes; and
selecting additional labeled data, based on the class information, the maximum additional training data count and the training data order of each of the classes, and a planned training data count.

8. A non-transitory computer readable storage medium including computer executable instructions, wherein the instructions, when executed by a processor, cause the processor to perform a method comprising:
predicting, based on unlabeled data, class information relating to a prediction class to which the unlabeled data is predicted to belong;
computing, from labeled data belonging to each class, a maximum additional training data count of each of the classes;
computing training data order of each of the classes from the maximum additional training data count of each of the classes; and
Selecting additional labeled data, based on the class information, the maximum additional training data count and the training data order of each of the classes, and a planned training data count.
